(19) United States
(12) Patent Application Publication
(10) Pub. No.: US 2025/0194562 A1
(43) Pub. Date: Jun. 19, 2025

(54) Animal Bathing Containment Device

(71) Applicant: Roel Walker, Kahului, HI (US)

(72) Inventor: Roel Walker, Kahului, HI (US)

(21) Appl. No.: 18/950,258

(22) Filed: Nov. 18, 2024

Related U.S. Application Data
(60) Provisional application No. 63/611,994, filed on Dec. 19, 2023.

(51) Int. Cl. A01K 13/00

(52) U.S. Cl. CPC A01K 13/001

(57) ABSTRACT

An animal bathing containment device is provided. The device is designed to facilitate the washing of an animal and is comprised of a body that includes a first end with an opening for placing animals inside the body, and a second end for draining water. The first end is equipped with a locking lid, made from wire or mesh material, featuring openings to spray water into the interior space. Additionally, the body incorporates a drainage hole to allow water to exit and a removable or valve-equipped drain plug at the second end to facilitate water drainage. The device may also feature a base raising the body above a ground surface.

### CROSS-REFERENCE TO RELATED APPLICATION

The present application claims priority to, and the benefit of, U.S. Provisional Application No. 63/611,994, which was filed on Dec. 19, 2023, and is incorporated herein by reference in its entirety.

### FIELD OF THE INVENTION

The present invention relates generally to the field of animal bathing. More specifically, the present invention relates to an animal bathing containment device that provides a device that an animal can be placed into and secured inside while being bathed. Accordingly, the present disclosure makes specific reference thereto. Nonetheless, it is to be appreciated that aspects of the present invention are also equally applicable to other like applications, devices, and methods of manufacture.

### BACKGROUND

Cats and various other animals might occasionally require bathing, especially if they acquire significantly dirty fur after spending time outdoors or if they become infested with fleas. However, most cats have a natural aversion to water, which can lead to adverse reactions during bathing attempts. This often results in a struggle between the cat and the person trying to bathe it, whether it be the owner or a professional groomer. In such scenarios, cats can become quite defensive, resorting to severe scratching and biting as a means of escape if they feel excessively restrained or threatened. Further, without proper handling techniques there is a risk that a cat might injure itself during these frantic efforts to avoid water. In extreme cases, the struggle can be intense, leading to potential injuries not just for the cat but also for the person involved, illustrating the challenges and precautions necessary when bathing animals that are resistant to water.

Therefore, there exists a long-felt need in the art for a device for bathing cats and other animals. There also exists a long-felt need in the art for an animal bathing containment device. More specifically, there exists a long-felt need in the art for an animal bathing containment device that secures an animal during bathing. In addition, there exists a long-felt need in the art for an animal bathing containment device that secures an animal during bathing wherein the device ensures the animal and bathing individual cannot be injured by one another.

The subject matter disclosed and claimed herein, in one embodiment thereof, comprises an animal bathing containment device. The device is designed to facilitate the washing of an animal and is comprised of a body that includes a first end with an opening for placing animals inside the body, and a second end for draining water. The first end is equipped with a locking lid, made from wire or mesh material, featuring openings to spray water into the interior space. Additionally, the body incorporates a drainage hole to allow water to exit and a removable or valve-equipped drain plug at the second end to facilitate water drainage. The device may also feature a base raising the body above a ground surface.

In this manner, the animal bathing containment device of the present invention accomplishes all the forgoing objectives and provides a device for bathing cats and other animals. More specifically, the device secures an animal during bathing. While doing so, the device ensures the animal and bathing individual cannot be injured by one another.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an animal bathing containment device comprised of a body comprised of a first end and a second end. The first end is comprised of at least one opening that allows a user to place an animal inside the interior space of the body.

The first end is comprised of at least one lid comprised of at least one opening that allows water to be sprayed through the lid (when closed) and into the interior space. The lid attaches to the first end via at least one hinge. The lid may be locked to the first end via at least one fastener. The body is also comprised of at least one drainage hole that allows water to exit the body when filling the interior space with water while washing an animal within the interior space.

The second end of the body may also be comprised of at least one drain plug that can be used to drain water from the interior space. In one embodiment, the drain plug can be removed from the second end to drain the body. In another embodiment, the plug is comprised of at least one valve that can be opened to allow water to drain from the interior space. In one embodiment, the device may be comprised of at least one base that suspends the body above a surface.

The present invention is also comprised of a method of using the device. First, a device is provided comprised of a body comprised of a drainage hole, an interior space, a lid, a fastener, a drain plug, and a base. Then, a user can open the lid and insert an animal into the interior space of the body. Then, a user can close the lid and secure the lid to the body via the fastener. Next, a user can spray water and/or cleaning products into the interior space such that the interior space fills with the water and/or cleaning product mixture and saturates the animal. Once the water and/or water mixture reaches a certain level of the body, the water and/or water mixture will automatically drain out the drainage hole. In a different embodiment, a user can also manually drain water and/or a water mixture from the interior space by removing or opening at least one drain plug.

Accordingly, the animal bathing containment device of the present invention is particularly advantageous as it provides a device for bathing cats and other animals. More specifically, the device secures an animal during bathing. While doing so, the device ensures the animal and bathing individual cannot be injured by one another. In this manner, the animal bathing containment device provides a solution to bathing a cat or other animal that may have an aversion to water.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an animal bathing containment device of the present invention with a closed lid in accordance with the disclosed architecture;

FIG. 2 illustrates a perspective view of one potential embodiment of an animal bathing containment device of the present invention with an open lid in accordance with the disclosed architecture;

FIG. 3 illustrates an enhanced perspective view of a bottom area of one potential embodiment of an animal bathing containment device of the present invention with a closed lid in accordance with the disclosed architecture; and

FIG. 4 illustrates a flowchart of a method of using one potential embodiment of an animal bathing containment device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for bathing cats and other animals. There also exists a long-felt need in the art for an animal bathing containment device. More specifically, there exists a long-felt need in the art for an animal bathing containment device that secures an animal during bathing. In addition, there exists a long-felt need in the art for an animal bathing containment device that secures an animal during bathing wherein the device ensures the animal and bathing individual cannot be injured by one another.

The present invention, in one exemplary embodiment, is comprised of an animal bathing containment device. The device is comprised of a body comprised of a first end and a second end, wherein the first end is comprised of at least one opening that allows a user to place an animal inside the interior space of the body.

The first end is also comprised of at least one lid comprised of at least one opening that allows water to be sprayed through the lid (when closed) and into the interior space. The lid attaches to the first end via at least one hinge and may be locked to the first end via at least one fastener. The body is also comprised of at least one drainage hole. The hole allows water to exit the body when filling the interior space with water while washing an animal within the interior space.

The second end of the body may also be comprised of at least one drain plug that can be used to drain water from the interior space. In one embodiment, the drain plug can be removed from the second end to drain the body. In another embodiment, the plug is comprised of at least one valve that can be opened to allow water to drain from the interior space. In one embodiment, the device may be comprised of at least one base that suspends the body above a surface.

The present invention is also comprised of a method of using the device. First, a device is provided comprised of a body comprised of a drainage hole, an interior space, a lid, a fastener, a drain plug, and a base. Then, a user can open the lid and insert an animal into the interior space of the body. Then, a user can close the lid and secure the lid to the body via the fastener. Next, a user can spray water and/or cleaning products into the interior space such that the interior space fills with the water and/or cleaning product mixture and saturates the animal. Once the water and/or water mixture reaches a certain level of the body, the water and/or water mixture will automatically drain out the drainage hole. In a different embodiment, a user can also manually drain water and/or a water mixture from the interior space by removing or opening at least one drain plug.

Accordingly, the animal bathing containment device of the present invention is particularly advantageous as it provides a device for bathing cats and other animals. More specifically, the device secures an animal during bathing. While doing so, the device ensures the animal and bathing individual cannot be injured by one another. In this manner, the animal bathing containment device provides a solution to bathing a cat or other animal that may have an aversion to water.

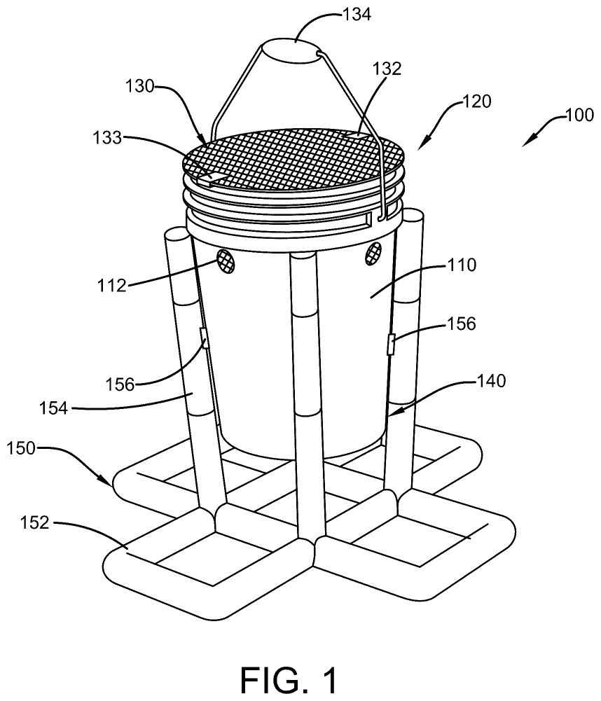

Referring initially to the drawings, FIG. 1 illustrates a perspective view of one potential embodiment of an animal bathing containment device 100 of the present invention with a closed lid 130 in accordance with the disclosed architecture. The device 100 is comprised of a body 110. The body 110 may be any shape, size, and configuration of body 110 known in the art may of any material. The body 110 is comprised of a first end 120 and a second end 140. The first end 120 is comprised of at least one opening 122. The opening 122 allows a user to place an animal inside the interior space 114 of the body 110.

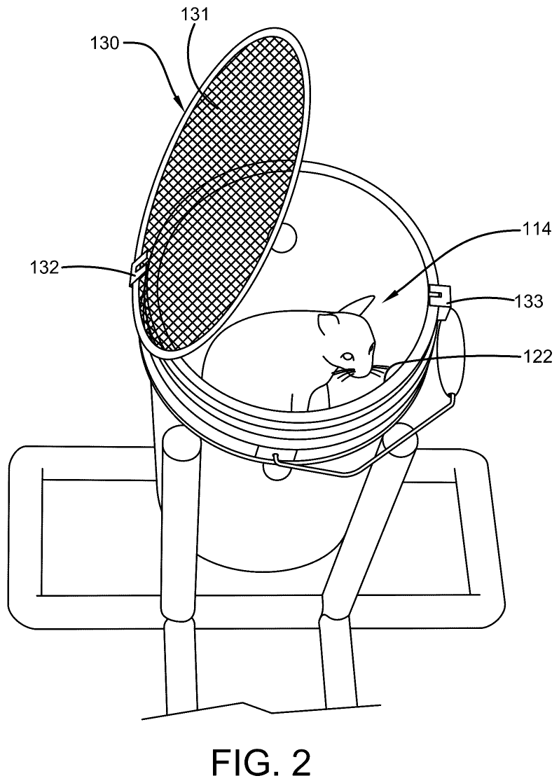

The first end 130 is comprised of at least one lid 130. The lid 130 is preferably comprised of at least one opening 131 that allows water to be sprayed through the lid 130 (when closed) and into the interior space 114. The lid 130 is preferably made from a wire and/or mesh material but may be made from any material comprised of at least one opening 131. The lid 130 attaches to the first end 120 via at least one hinge 132 of any type, as seen in FIG. 2. The lid 130 may be locked to the first end 120 via at least one fastener 133 such as but not limited to a clip, a clamp, a lock, or any similar type of fastener known in the art. The body 110 may also be comprised of at least one handle 134 of any type/style that allows the body 110 to be easily moved.

The body 110 is also comprised of at least one drainage hole 112. The drainage hole 112 may be positioned anywhere on the body 110 and in any pattern. The hole 112 may also be of any size. The hole 112 allows water to exit the body 110 when filling the interior space 114 with water while washing an animal within the interior space 114. The hole 112 is preferably a rustproof, screened-hole to prevent an animal inside the body 110 from reaching through the hole.

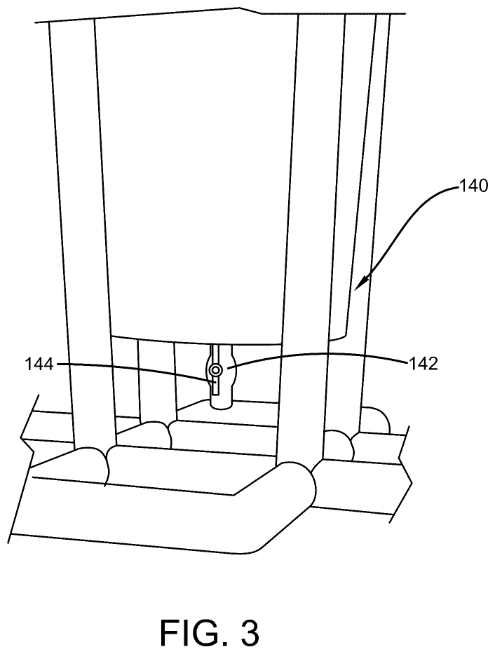

The second end 140 of the body 110 may also be comprised of at least one drain plug 142 that can be used to drain water from the interior space 114. In one embodiment, the drain plug 142 can be removed from the second end 140 to drain the body 110. In another embodiment, the plug 142 is comprised of at least one valve 144 (as seen in FIG. 3) that can be opened to allow water to drain from the interior space 114.

In one embodiment, the device 100 may be comprised of at least one base 150 that suspends the body 110 above a surface. The base 150 may be any style and configuration of base 150 and may be comprised of at least one horizontal member 152 and/or at least one vertical member 154. The vertical member 154 and/or horizontal member 152 may attach to the body 110 via at least one fastener 156 such as but not limited to a screw, a bolt, a clamp, a clip, a suction cup, a tongue, a groove, a receiving area, etc. Both or either member 152,154 may be comprised of a telescopic member in different embodiments.

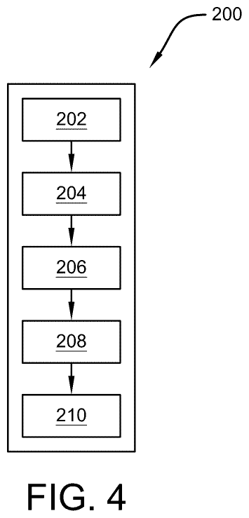

The present invention is also comprised of a method of using 200 the device 100, as seen in FIG. 4. First, a device 100 is provided comprised of a body 110 comprised of a drainage hole 112, an interior space 114, a lid 130, a fastener 133, a drain plug 142, and a base 150 [Step 202]. Then, a user can open the lid 130 and insert an animal into the interior space 114 of the body 110 [Step 204]. Then, a user can close the lid 130 and secure the lid 130 to the body 110 via the fastener 133 [Step 206]. Next, a user can spray water and/or cleaning products into the interior space 114 such that the interior space 114 fills with a liquid such as but not limited to water and/or a cleaning product mixture and saturates the animal [Step 208]. Once the water and/or water mixture reaches a certain level of the body 110, the water and/or water mixture will automatically drain out the drainage hole 112. In a different embodiment, a user can also manually drain water and/or a water mixture from the interior space 114 by removing or opening at least one drain plug 142 [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “animal bathing containment device” and “device” are interchangeable and refer to the animal bathing containment device 100 of the present invention.

Notwithstanding the forgoing, the animal bathing containment device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the animal bathing containment device 100 as shown in the FIGS. are for illustrative purposes only, and that many other sizes and shapes of the animal bathing containment device 100 are well within the scope of the present disclosure. Although the dimensions of the animal bathing containment device 100 are important design parameters for user convenience, the animal bathing containment device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An animal bathing containment device comprising:
a body comprised of:
an opening;
an interior space;
a drainage hole;
a lid; and
a drain plug.

2. The animal bathing containment device of claim 1, wherein the lid is comprised of a wire material or a mesh material.

3. The animal bathing containment device of claim 1 further comprised of a fastener that secures the lid to the body.

4. The animal bathing containment device of claim 2, wherein the fastener is comprised of a clip, a clamp, or a lock.

5. The animal bathing containment device of claim 1 further comprised of a handle.

6. The animal bathing containment device of claim 1, wherein the drainage hole is comprised of a screened drainage hole.

7. The animal bathing containment device of claim 1, wherein the drain plug is comprised of a valve.

8. An animal bathing containment device comprising:
a body comprised of:
an opening;
a base;
an interior space;
a drainage hole;
a lid attached to the body via hinge; and
a drain plug.

9. The animal bathing containment device of claim 8, wherein the lid is comprised of a wire material or a mesh material.

10. The animal bathing containment device of claim 8 further comprised of a first fastener that secures the lid to the body.

11. The animal bathing containment device of claim 10, wherein the first fastener is comprised of a clip, a clamp, or a lock.

12. The animal bathing containment device of claim 8 further comprised of a handle.

13. The animal bathing containment device of claim 8, wherein the drainage hole is comprised of a screened drainage hole.

14. The animal bathing containment device of claim 8, wherein the drain plug is comprised of a valve.

15. The animal bathing containment device of claim 8, wherein the base is comprised of a horizontal member.

16. The animal bathing containment device of claim 8, wherein the base is comprised of a vertical member.

17. The animal bathing containment device of claim 8, wherein the base attaches to the body via a second fastener.

18. A method of using an animal bathing containment device, the method comprising the following steps:
providing an animal bathing containment device comprised of a body comprised of a drainage hole, an interior space, a lid, a fastener, a drain plug, and a base;
opening the lid and inserting an animal into the interior space;
closing the lid and securing the lid to the body via the fastener; and
spraying a liquid into the interior space to wash the animal.

19. The method of using an animal bathing containment device of claim 18 further comprised of a step of removing the drain plug.

20. The method of using an animal bathing containment device of claim 18 further comprised of a step of opening a valve of the drain plug.
